(19) United States
(12) Patent Application Publication
(10) Pub. No.: US 2017/0316526 A1
(43) Pub. Date: Nov. 2, 2017

(54) INTERFACES AND METHODS FOR LICENSING MEDIA

(71) Applicant: Andrew Knox Music Productions, d.b.a. Stock Anatomy, Valencia, PA (US)

(72) Inventor: Andrew Knox, Valencia, PA (US)

(21) Appl. No.: 15/143,809

(22) Filed: May 2, 2016

(51) Int. Cl. G06Q 50/18; G06Q 30/02

(52) U.S. Cl. CPC G06Q 50/184; G06Q 30/0283

(57) ABSTRACT

Embodiments are directed to purchasing and storing media licenses and to identifying and presenting media licenses base on parameters. In one scenario, a computer system instantiates a user interface that includes the following: a field configured to present information relating to identified media licenses, an actionable element that allows selection of the type of media license to be acquired by a user for a selected media item, a field that displays a determined price for the selected type of media license, and an actionable element that processes payment for the selected type of media license. The purchased license is added to a collection of media licenses that includes the purchased media license and any previously purchased media licenses.

### BACKGROUND

Computers have become highly integrated in the workforce, in the home, in mobile devices, and many other places. Computers can process massive amounts of information quickly and efficiently. Software applications designed to run on computer systems allow users to perform a wide variety of functions including business applications, schoolwork, entertainment and more. Software applications are often designed to perform specific tasks, such as word processor applications for drafting documents, or email programs for sending, receiving and organizing email.

In some cases, software applications may be designed to access data stored in local or remote data stores. These data stores are often referred to as databases. Computer databases allow applications to request data using queries. When the database receives the query, it looks up data corresponding to the query and returns the data to the application. Substantially any type of data may be stored in a database, including, for example, media items and data associated therewith. The media items may include songs, movies, photos or other types of media. The information associated with the media items may include, for example, title, album, artist, photographer, or other information. Indeed, in some cases, the data may include licensing information associated with the media items.

### BRIEF SUMMARY

Embodiments described herein are directed to purchasing and storing media licenses and to identifying and presenting media licenses base on parameters. In one embodiment, a computer system instantiates a user interface that includes the following: a field configured to present information relating to identified media licenses, an actionable element that allows selection of the type of media license to be acquired by a user for a selected media item, a field that displays a determined price for the selected type of media license, and an actionable element that processes payment for the selected type of media license. The purchased license is added to a collection of media licenses that includes the purchased media license and any previously purchased media licenses.

In another embodiment, a computer system identifies and presenting media licenses base on parameters. The computer system receives inputs identifying a parameter that is to be matched to different media licenses or media license types. Based on the parameter, the computer system identifies media licenses that correspond to the parameter, displays the identified media licenses for selection by a user and, upon selection by the user, adds the media license to a collection of media licenses that are to be purchased.

In yet another embodiment, a computer system is provided that includes the following: a processor, a display for displaying information relating to identified media licenses, an input receiver for receiving input indicating that a specified type of media license is to be acquired by a user, a price calculating module that determines a price for the selected type of media license, where the display displays the determined price for the selected type of media license, and a payment processor that causes payment to be processed for the selected type of media license, where the purchased media license is added to a collection of media licenses including the purchased license and any previously purchased media licenses.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates a computer architecture in which embodiments described herein may operate including identifying and presenting media licenses base on parameters.

FIGS. 2A-2P illustrate embodiments in which a media license is displayed, selected and purchased.

FIGS. 3A-3E illustrate an embodiment in which a media license is shared with an authorized user.

FIGS. 4A-4C illustrate an embodiment in which a media license is shared with an unauthorized user.

FIG. 5 illustrates a flowchart of an example method for identifying and presenting media licenses base on parameters.

### DETAILED DESCRIPTION

Embodiments described herein are directed to purchasing and storing media licenses and to identifying and presenting media licenses base on parameters. In one embodiment, a computer system instantiates a user interface that includes the following: a field configured to present information relating to identified media licenses, an actionable element that allows selection of the type of media license to be acquired by a user for a selected media item, a field that displays a determined price for the selected type of media license, and an actionable element that processes payment for the selected type of media license. The purchased license is added to a collection of media licenses that includes the purchased media license and any previously purchased media licenses.

In another embodiment, a computer system identifies and presenting media licenses base on parameters. The computer system receives inputs identifying a parameter that is to be matched to different media licenses or media license types. Based on the parameter, the computer system identifies media licenses that correspond to the parameter, displays the identified media licenses for selection by a user and, upon selection by the user, adds the media license to a collection of media licenses that are to be purchased.

In yet another embodiment, a computer system is provided that includes the following: a processor, a display for displaying information relating to identified media licenses, an input receiver for receiving input indicating that a specified type of media license is to be acquired by a user, a price calculating module that determines a price for the selected type of media license, where the display displays the determined price for the selected type of media license, and a payment processor that causes payment to be processed for the selected type of media license, where the purchased media license is added to a collection of media licenses including the purchased license and any previously purchased media licenses.

The media license purchasing and identifying embodiments described herein may be implemented on various types of computing systems. These computing systems may take a wide variety of forms. Such computing systems may, for example, be mobile phones, electronic appliances, laptop computers, tablet computers, wearable devices, desktop computers, mainframes, and the like. As used herein, the term “computing system” includes any device, system, or combination thereof that includes at least one processor, and a physical and tangible computer-readable memory capable of having thereon computer-executable instructions that are executable by the processor. A computing system may be distributed over a network environment and may include multiple constituent computing systems.

A computing system typically includes at least one processing unit and memory. The memory may be physical system memory, which may be volatile, non-volatile, or some combination of the two. The term “memory” may also be used herein to refer to non-volatile mass storage such as physical storage media or physical storage devices. If the computing system is distributed, the processing, memory and/or storage capability may be distributed as well.

As used herein, the term “executable module” or “executable component” can refer to software objects, routines, methods, or similar computer-executable instructions that may be executed on the computing system. The different components, modules, engines, and services described herein may be implemented as objects or processes that execute on the computing system (e.g., as separate threads).

As described herein, a computing system may also contain communication channels that allow the computing system to communicate with other message processors over a wired or wireless network. Such communication channels may include hardware-based receivers, transmitters or transceivers, which are configured to receive data, transmit data or perform both.

Embodiments described herein also include physical computer-readable media for carrying or storing computer-executable instructions and/or data structures. Such computer-readable media can be any available physical media that can be accessed by a general-purpose or special-purpose computing system.

Computer storage media are physical hardware storage media that store computer-executable instructions and/or data structures. Physical hardware storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computing system to implement the disclosed functionality of the embodiments described herein. The data structures may include primitive types (e.g. character, double, floating-point), composite types (e.g. array, record, union, etc.), abstract data types (e.g. container, list, set, stack, tree, etc.), hashes, graphs or other any other types of data structures.

As used herein, computer-executable instructions comprise instructions and data which, when executed at one or more processors, cause a general-purpose computing system, special-purpose computing system, or special-purpose processing device to perform a certain function or group of functions. Computer-executable instructions may be, for example, binaries, intermediate format instructions such as assembly language, or even source code.

Those skilled in the art will appreciate that the principles described herein may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The embodiments herein may also be practiced in distributed system environments where local and remote computing systems, which are linked (either by hardwired data links, wireless data links, or by a combination of hardwired and wireless data links) through a network, both perform tasks. As such, in a distributed system environment, a computing system may include a plurality of constituent computing systems. In a distributed system environment, program modules may be located in both local and remote memory storage devices.

Those skilled in the art will also appreciate that the embodiments herein may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

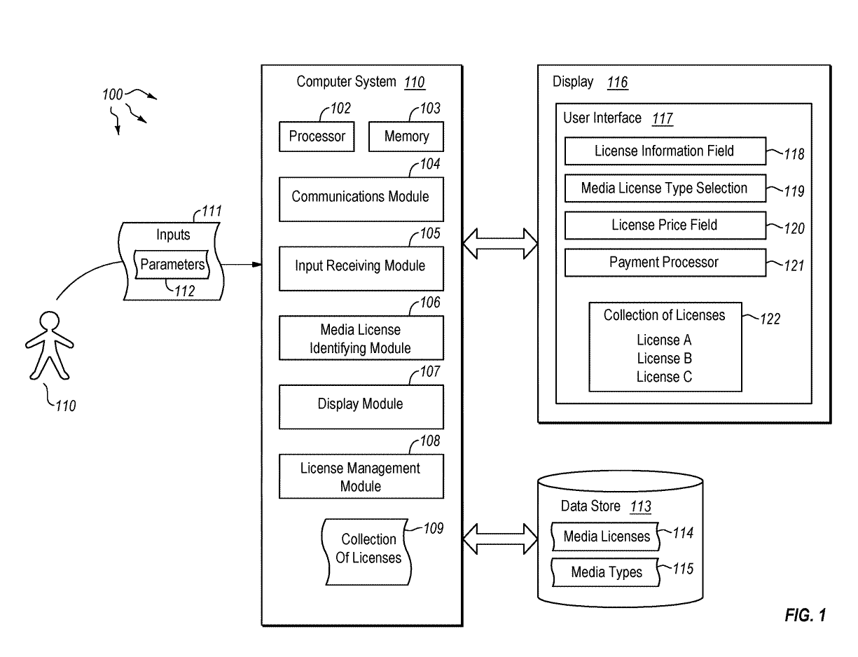

Referring to the figures, FIG. 1 illustrates a computer architecture 100 in which at least one embodiment described herein may be employed. The computer architecture 100 includes a computing system 101. The computing system 101 may be any type of local or distributed computing system, including a cloud computing system. The computing system 101 includes at least one hardware processor 102, at least one hardware memory 103, and one or more modules for performing different functions. Each module may include hardware, software, or a combination of both. Indeed, in some cases, a functional module may include a special purpose processor configured to perform a specific function. The special purpose processor may work with other hardware elements to perform a function defined by software code. This software code may be embedded in the hardware processor (e.g. an ASIC or System on a Chip) or may be stored in a separate location.

In addition to processor and memory hardware components, the computer system 101 may include a communications module 104 may be configured to communicate with other computing systems. The communications module 104 may include any wired or wireless communication means that can receive and/or transmit data to or from other computing systems including WiFi, Bluetooth, cellular or other radios. The communications module 104 may be configured to interact with databases, mobile computing devices (such as mobile phones or tablets), embedded or other types of computing systems.

The computer system 101 also includes an input receiving module 105 configured to receive inputs 111 from user 110. The inputs 111 may, of course, be received from other users or other computer systems. The inputs 111 may include parameters 112 which are used to identify music licenses. For example, user 110 may wish to purchase a license for a given media item such as a movie or song. The user may provide one or more parameters that will be used by the media license identifying module 106 to identify media licenses 114 stored in data store 113, or stored in some other data store.

In some embodiments, for example, user 110 may use a user interface 117 presented on display 116 to select the parameters 112 that are to be matched by the media license identifying module 106. The user interface 117 may include different fields (e.g. license information field 118) which are used by the user to select parameters, select licenses, view license information, or perform other functionality. For instance, the license information field 118 may be configured to display information relating to one or more media licenses 114. The license information may include details about the media item such as its title, license owner, album, publisher, release date, track code, union talent indication, exclusivity indication, content type, description of the media item, composer, tempo, length, similar media items or other information. Indeed, it will be understood that may other types of detail information may be included in addition to or as alternatives to the above-identified items.

The user interface 117 may include other fields such as a media license type selection field 119 that allows the user 110 to select which type of media license the user wishes to purchase. Many different types of licenses or “clearances” may be purchased. For example, the user 110 may wish to purchase a non-broadcast license, or an internet license, a license for broadcast commercials or broadcast programs, a license for a public venue, a license for a film, or a license for a commercial package. Again, it will be understood that other types of licenses not identified above may be presented and/or purchased using user interface 117.

The license price field 120 may show the price of a selected license. Each type of license may have a different price. This price may be set by the owner of the corresponding media item or by another entity. In some cases, the price may be dictated by or at least partially subject to current market prices. These prices may be determined by a third party agency or by some other entity.

In other cases, the content provider or content owner may upload their own content and establish their own price for that content. If the content provider or owner does not want to indicate a cost for a clearance for their content, then they may indicate such in a variety of different ways. In such cases where a cost is not supplied by a content provider or owner, when a customer attempts to view the clearance and its associated price, the letter or symbol in the “Price” field may indicate that a quote is to be requested. This quote may be requested automatically, or may first query the customer for input verifying their desire for a quote.

Thus, a customer may use the user interface 117 to select one or more clearances. If the clearance does not have a price, the system (e.g. 101) may provide inputs that guide the customer to request a quote. After the customer has requested a quote, the content provider or owner receives a notification that the customer has requested a quote. The content provider or owner then enters a cost for the clearance. The input receiving module 105 of computer system 101 then receives the cost for the clearance and, at least in some embodiments, adds a transaction fee (e.g. 15%) on top of the indicated cost or deducts the amount of the transaction fee from the total fee. The quote is then shown to the customer. The customer can accept or deny the quote and, if the quote is accepted, the content provider or owner can indicate to the computer system 101 to create an invoice between the customer and the content provider. Both parties may then receive hard or soft copies of the invoice. Soft copies, (i.e. electronic copies), may be transmitted directly to the user in the form of a word processing document, a spreadsheet, a portable document format (PDF) document or some other electronic form. Hard copies may be sent via traditional postal mail. As such, content providers or owners can withhold license costs initially, and then provide them later on demand when the customer asks for such.

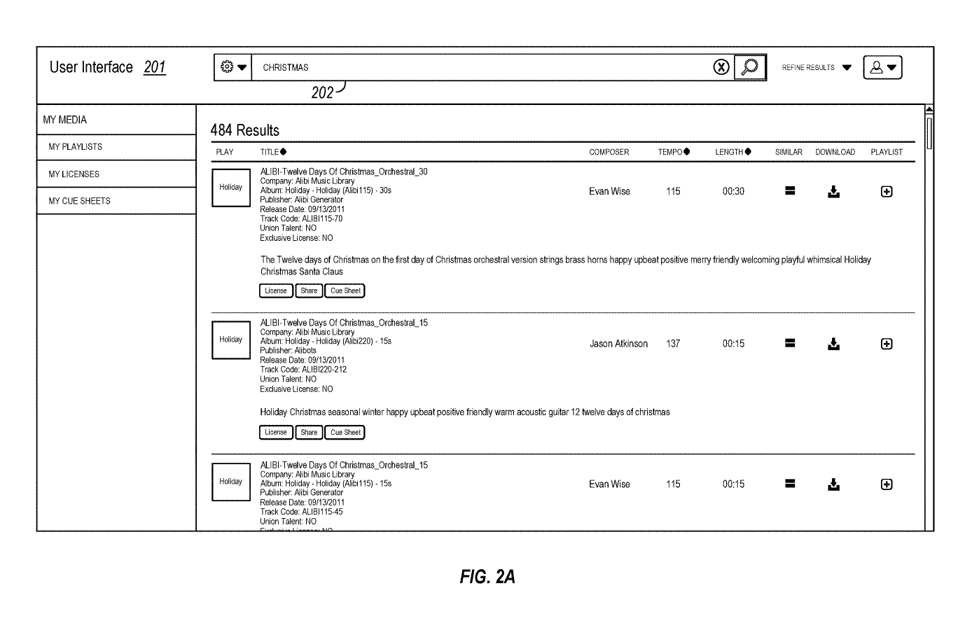

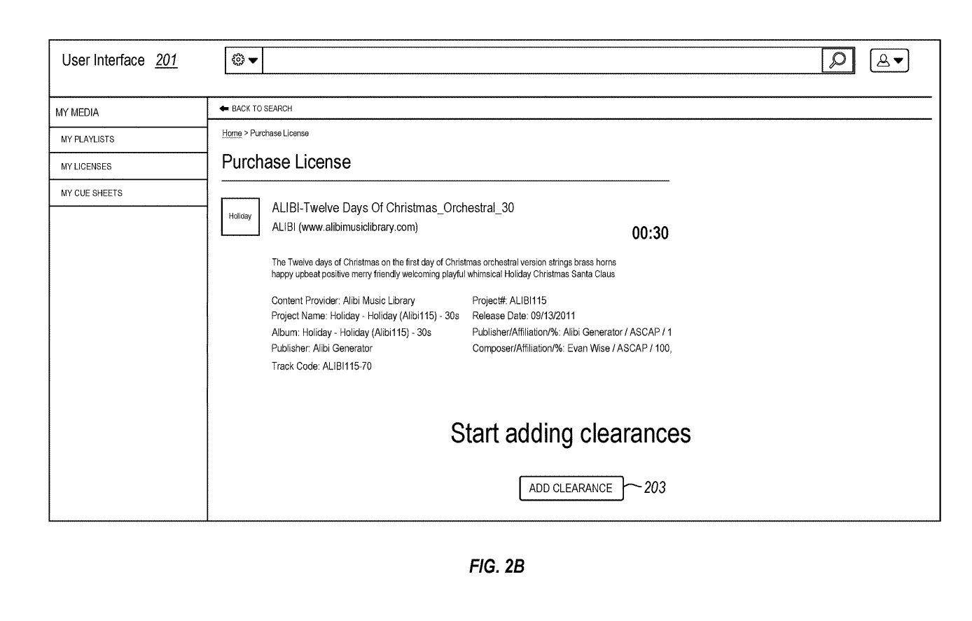

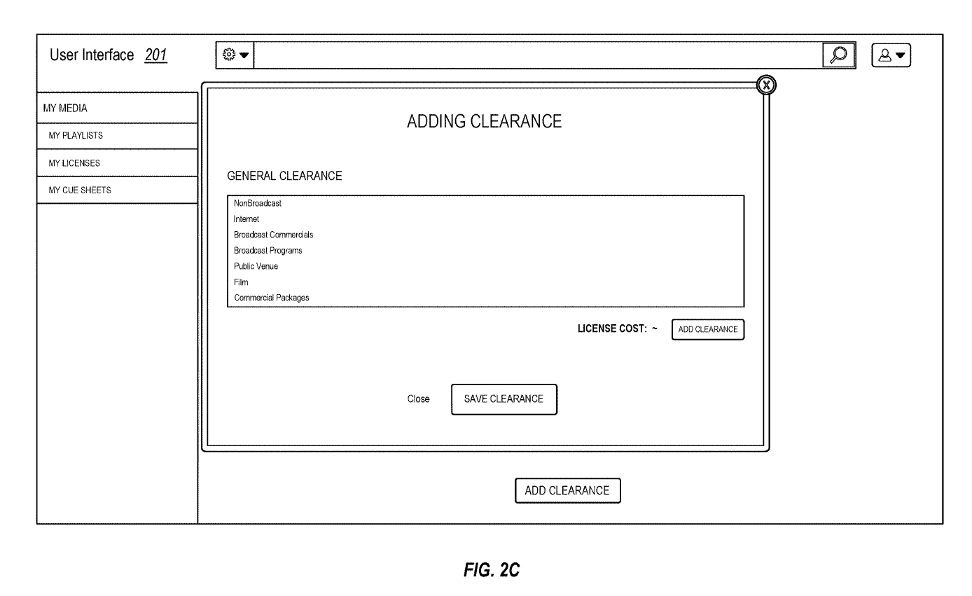

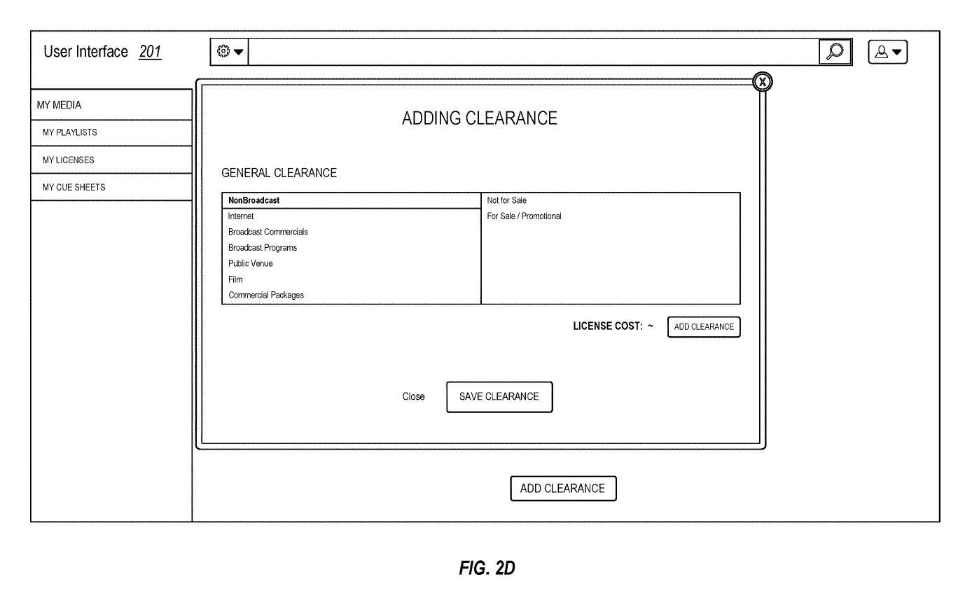

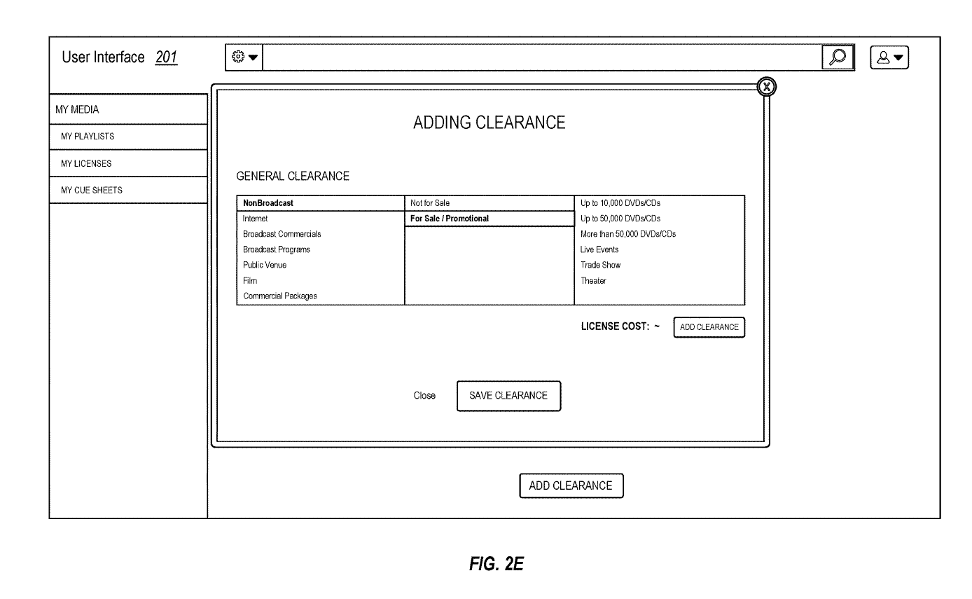

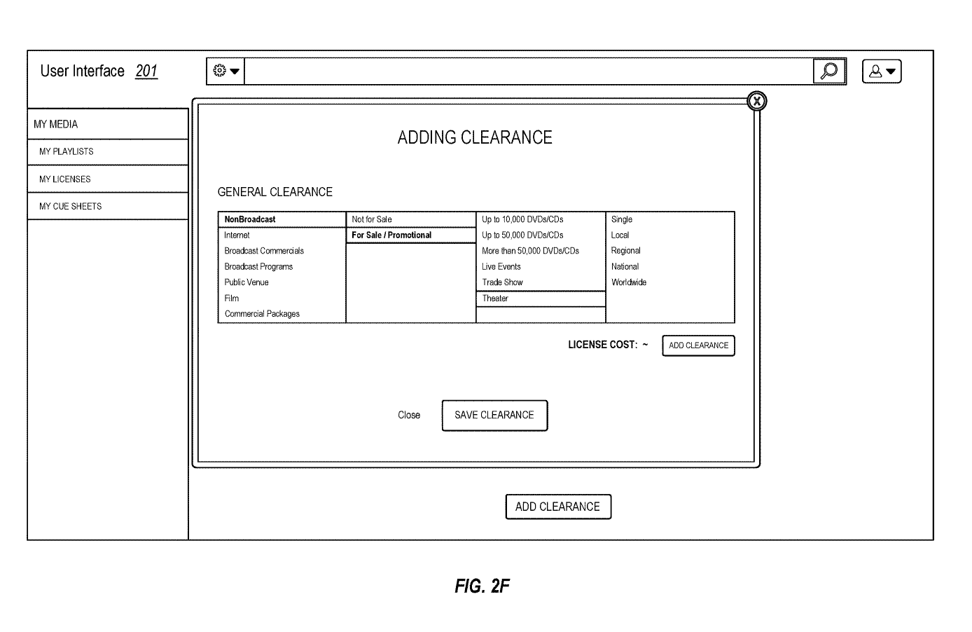

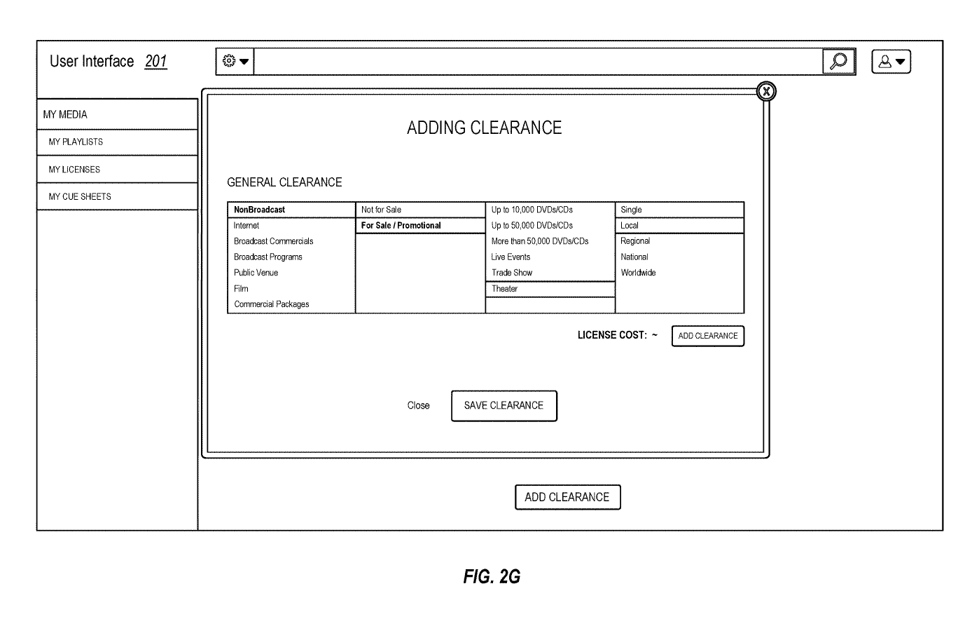

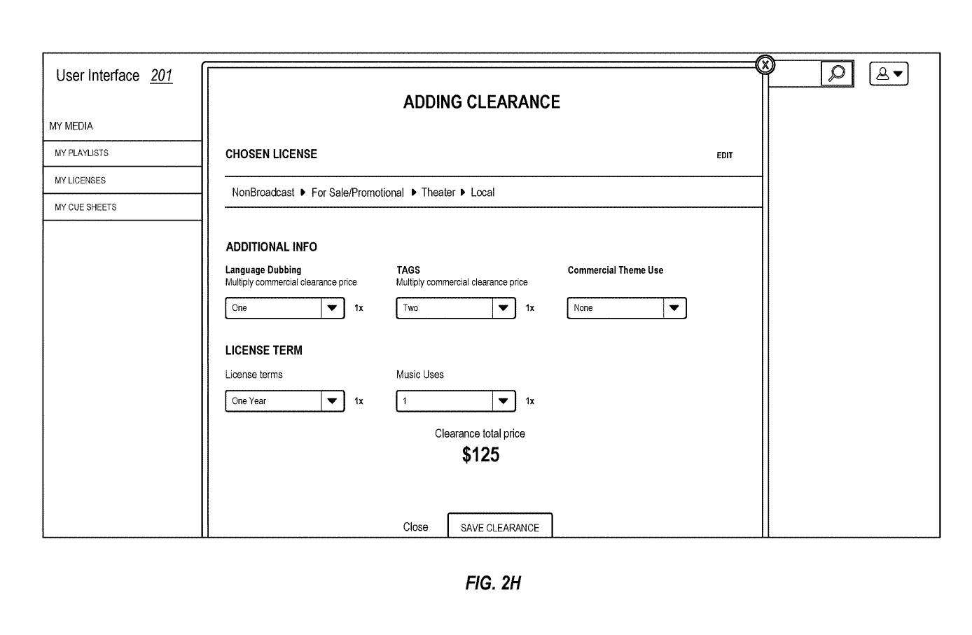

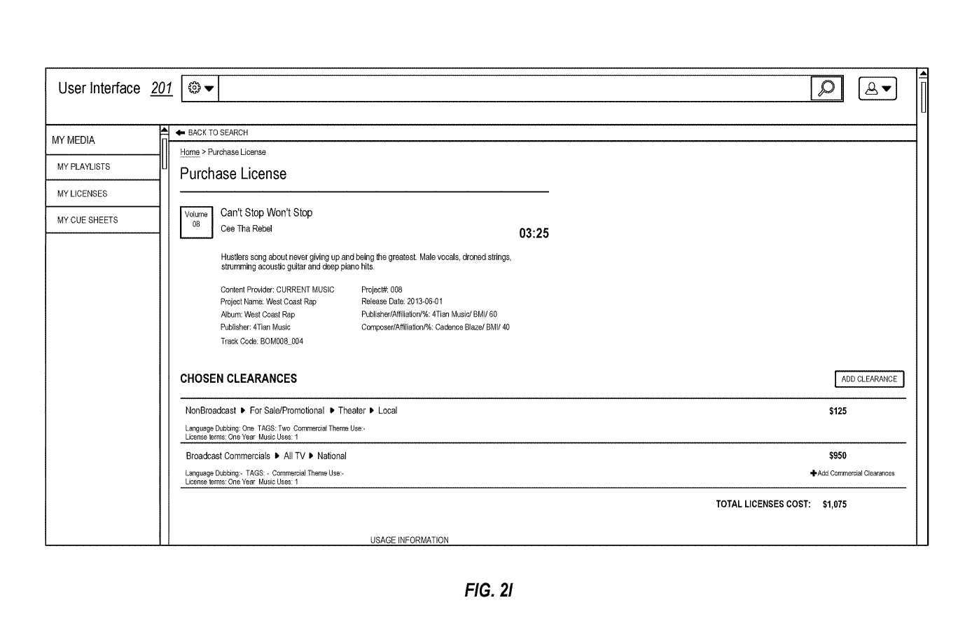

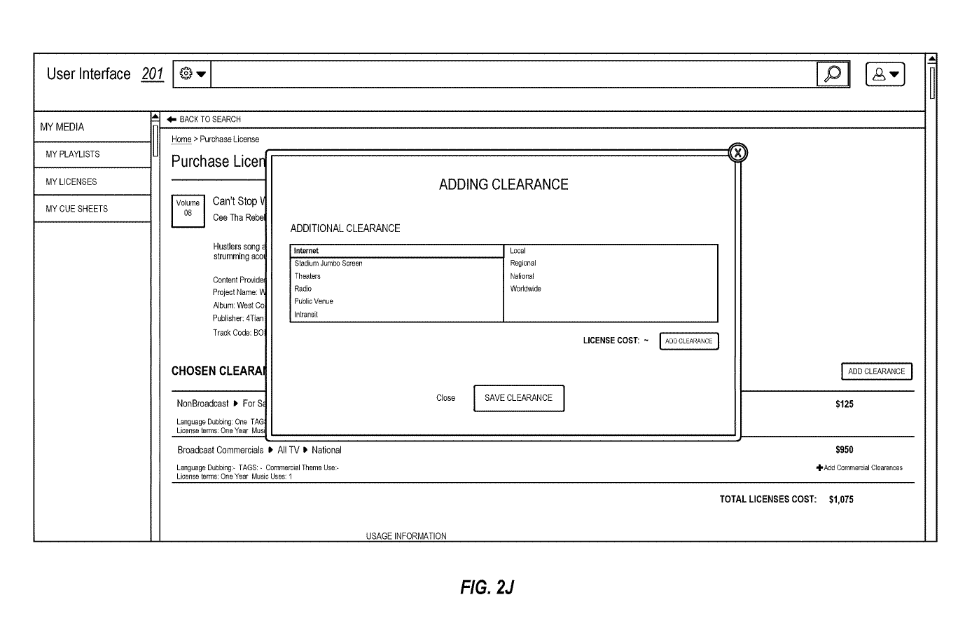

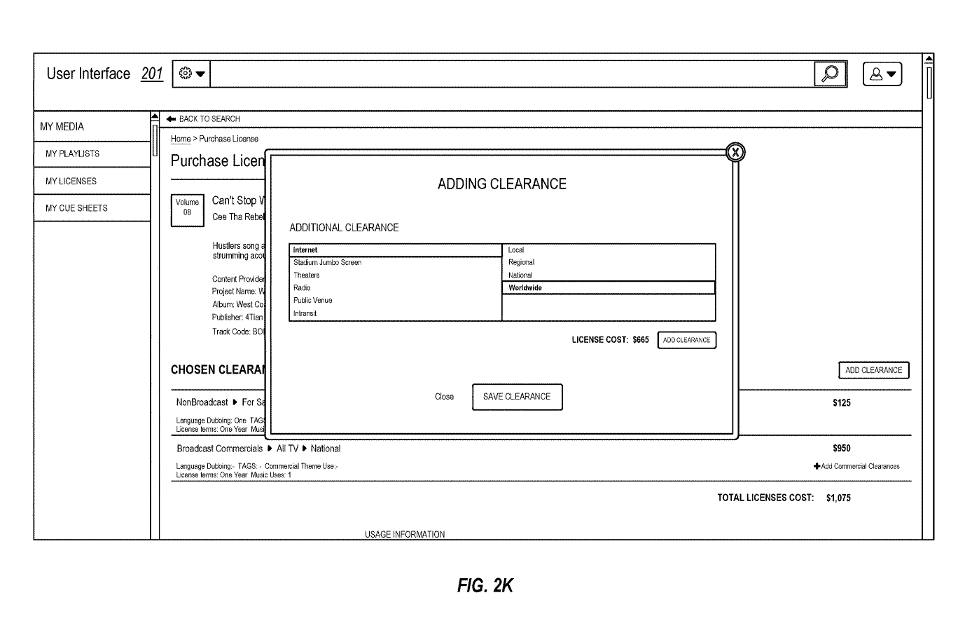

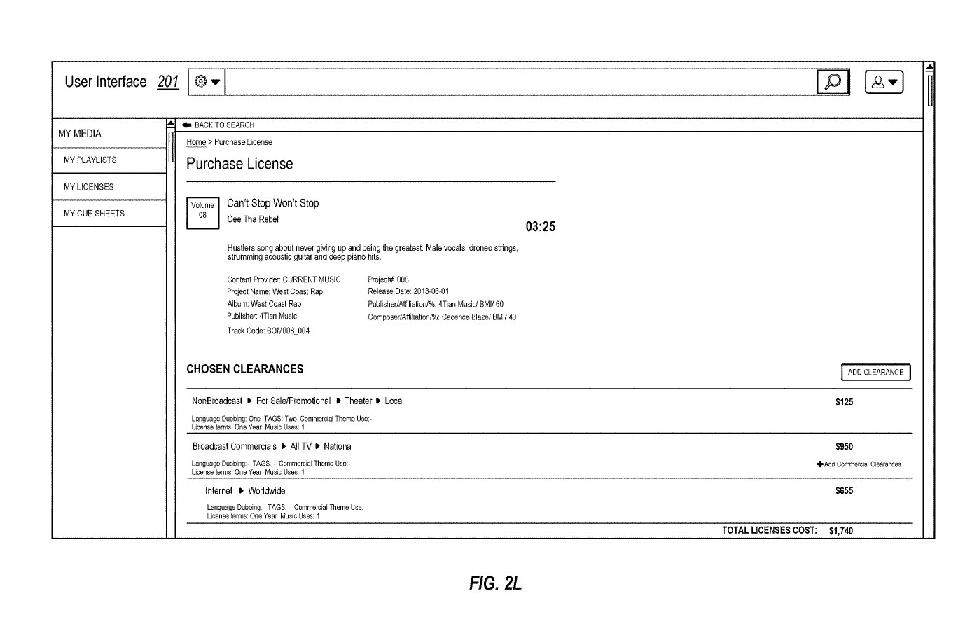

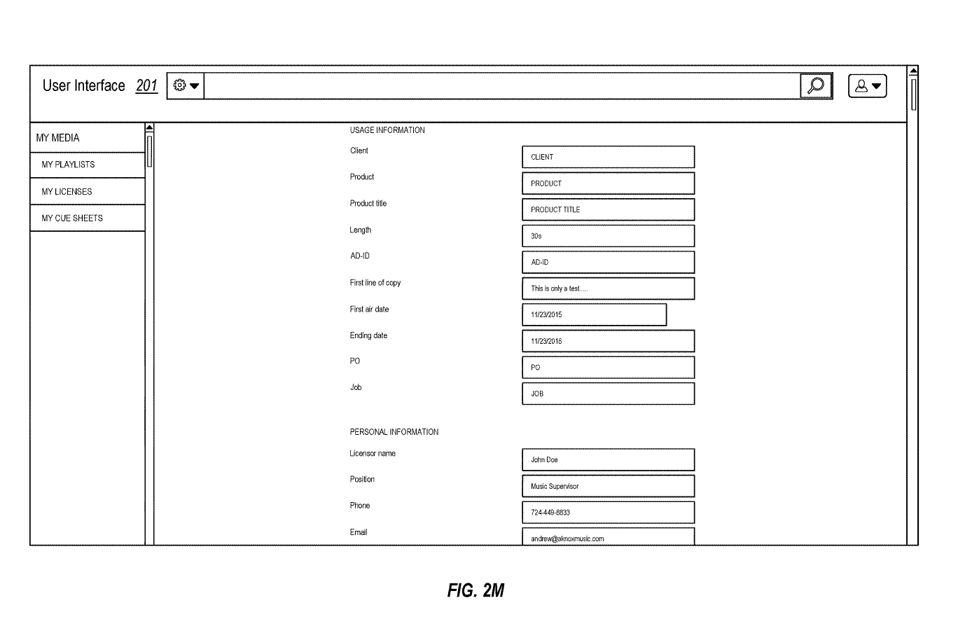

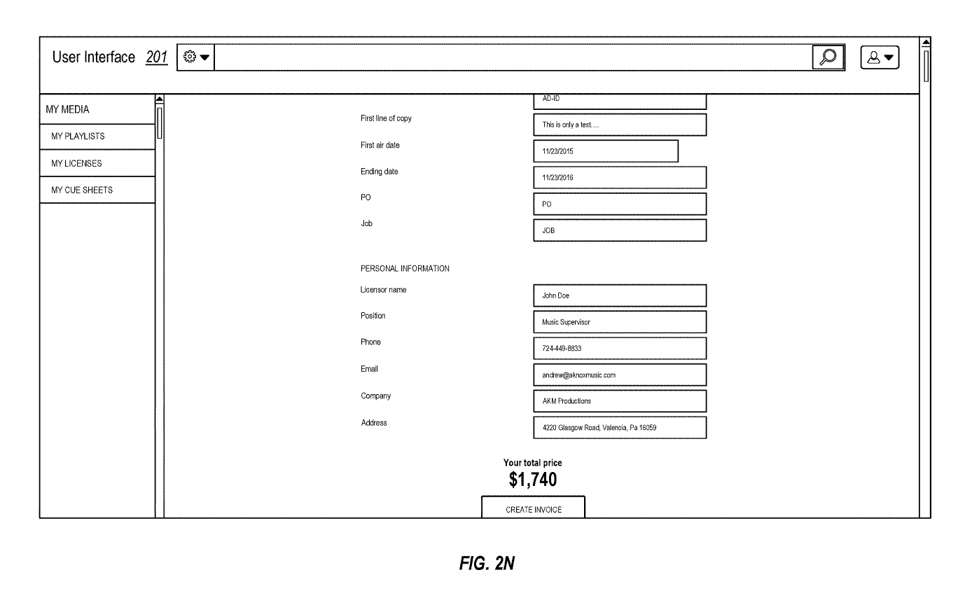

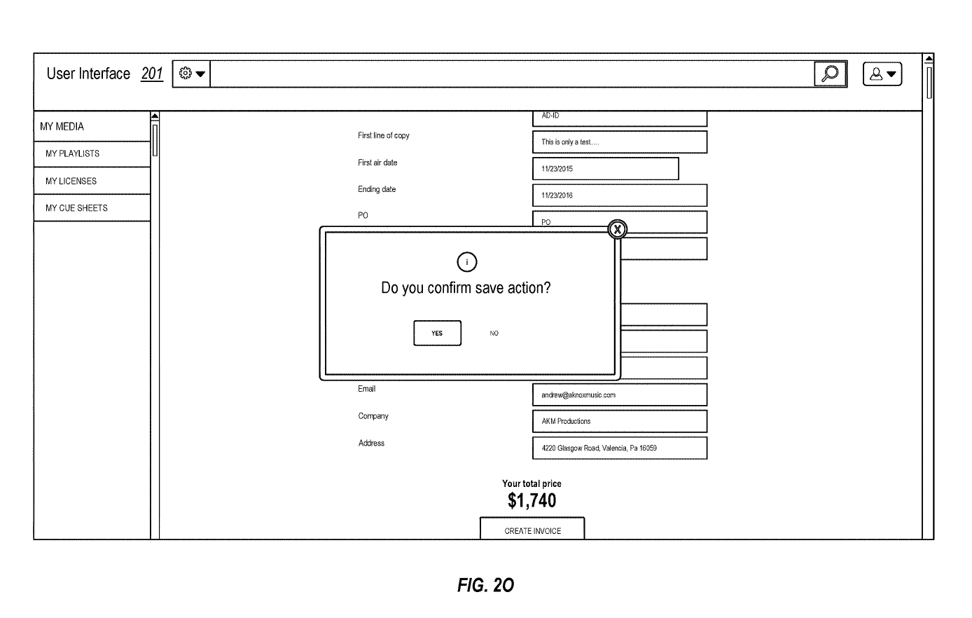

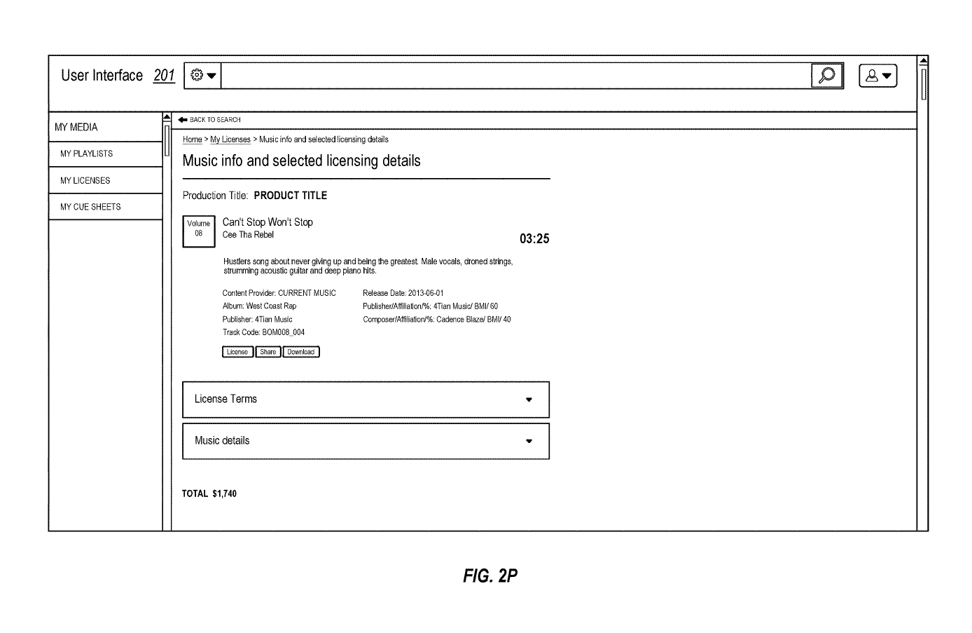

Once the final prices have been determined for the licenses, the payment processor UI element 121 may allow a user to initiate payment for the license(s). The UI 117 may display those licenses that are to be purchased by the user. This may be a single license or multiple licenses, and may include a specified collection of licenses 122 that, at least in FIG. 1, includes licenses A, B and C. The UI 117 and its corresponding elements will be described in greater detail below with regard to FIGS. 2A-2P.

One embodiment herein is a computer program product that includes one or more computer storage media that have computer-executable instructions stored thereon. When executed by one or more processors of a computing system, the computer-executable instructions cause the computing system to instantiate a user interface (e.g. UI 117). The UI includes a license information field 118 configured to present information relating to identified media licenses 114. The UI also includes an actionable element (e.g. media license type selection) that allows selection of the type of media license to be acquired by a user for a selected media item.

As shown in FIG. 2A, user interface 201 includes a list of media items that match the search term “Christmas” as indicated in search bar 202. In the Results area, 484 media item results are indicated as matching the term “Christmas.” Only the first three results are shown in the Results area. Each media item has multiple portions of information shown in the license information field 118. This information may include the media item's title, license owner, album, publisher, release date, track code, union talent indication, exclusivity indication, content type, description of the media item, composer, tempo, length, similar media items or other information. The UI user 110 may scroll through the list of media items to identify which they may be interested in licensing.

In FIG. 2B, the user is shown as having selected “ALIBI-Twelve Days of Christmas_Orchestral_30.” From this screen, the user may review additional license information related to the media item, and may also add clearances by selecting the “Add Clearance” button 203. Selecting button 203 brings the user to the UI screen shown in FIG. 2C. In the Adding Clearance window, the user may choose from the various license types available for that media item (e.g. via media license type selection field 119). The license types may include non-broadcast, internet, broadcast commercial, broadcast program, public venue, film, commercial package, or other license type. The “License Cost” field may indicate the price of each license type when that license type is selected. For example, if the user 110 selected an “Internet” license, the cost for the internet license would be shown in the License Cost field. From here, the user could either add the license to their collection of licenses that are to yet to be purchased, or could exit out of the window and view other media items.

FIG. 2D illustrates an example where the user has selected a non-broadcast license. Within the non-broadcast license, other options are also presented including “Not for Sale” and “For Sale/Promotional.” Different prices may be associated with non-broadcast licenses for media items that are for sale or are promotional versus items that are not for sale. Again, the price for each license type may be shown in the “License Cost” field. In some cases, licenses may be geographically limited to one or more given countries (e.g. to the United States or to Canada). International or worldwide licenses may also be available. Each country may have its own license cost associated with it. Or, in some cases, multiple countries may be available together in a package deal. In some cases, the pricing may also depend on the origin of the media item, or the country in which the licensing user 110 is based.

Thus, as shown in FIG. 1, the UI 117 may include a license price field 120 that displays a determined price for the selected type of media license (whether domestic, international, for sale, not for sale, etc.). The price for each license type may be manipulated and/or modified for each user. Thus, depending on a variety of factors including identity of user, location of user, license purchasing history, current market demand, time of year (e.g. higher prices for Christmas songs during Christmas time), or other factors. The price for each license may be determined by preset market figures or current consumer demand. The price may also be set by machine learning based on comparable licenses and market demand in the user's local market or in the worldwide market. In this manner, the pricing may be dynamic and individualized for each user.

The UI 117 also includes a payment processor element 121 that is actionable to process payment for the type of media license selected by the user 110. The payment processor may be linked with banks or credit card companies to process payments. Any purchased licenses are added to a collection of media licenses 12 that includes the recently purchased media license and any other previously purchased media licenses. The user 110 may be able to scroll through or search their purchased licenses for a specific license or license type.

FIG. 2E illustrates an embodiment where the user 110 has selected a non-broadcast license for media items that are for sale or are promotional. Within such licenses, more options may be displayed in UI 201 including an option for up to 10,000 DVDs/CDs, up to 50,000 DVDs/CDs, more than 50,000 DVDs/CDs, live events, trade shows or for theater. Each of these options may have a separate cost for the license. In this manner, users may use UI 201 to purchase very specific licenses for each media item. If the user selects the “theater” option (see FIG. 2F), a further list of use types may be displayed including a single use, local use, regional use, national use or worldwide use. Again, each option may have a different price associated with it. As shown in FIG. 2G, the price for a local theater license is $1,000. This license may be added to the user's shopping cart by selecting the “Add Clearance” button.

FIG. 2H shows an embodiment where a non-broadcast, for sale or promotional, local theater license has been selected by user 110. Additional information related to that specific license may be shown in the UI 201. For example, language dubbing options, tags, commercial theme use options, license term length and music uses, among other items, may be shown in the Adding Clearance window of FIG. 2H. Each option may add to or subtract from the total price. Presently, the selected license is $125.

FIG. 2I shows an embodiment of UI 201 where two clearances have already been added to the user's shopping cart. The first is a non-broadcast, for sale or promotional local theater license for $125, and the second is a broadcast commercial, all tv, national license for $950. The user is also viewing a media item “Can't Stop Won't Stop” with its associated media license information (i.e. the information shown in the license information field 118). FIG. 2J shows that the user has opted to add clearances. In the “Adding Clearance” window of FIG. 2J, an internet license is selected, and options for local, regional, national and worldwide licenses are shown. FIG. 2K shows that the user has selected a worldwide internet license, and that the cost associated with that license is $665. FIG. 2L is similar to FIG. 2I, but also includes the worldwide internet license for $665 in the user's chosen clearances.

Once the user 110 has finished selecting licenses, they may view usage information as shown in FIG. 2M. The usage information may include a client name, product name, product title, length of the clip, ad identifier, first line of copy, first air date, ending date, PO, job identifier and personal information including licensor name, position, phone, email, company name, address, etc. Other usage or personal information may also be shown in the window of FIG. 2M.

FIG. 2N displays the total price for all of the selected licenses ($1,740 in this case), and FIG. 2O allows the user to confirm whether an invoice is to be created (e.g. by the payment processor 121 of FIG. 1). Upon selecting yes in FIG. 2O, a Music Info and Licensing Details window may be displayed as shown in FIG. 2P. This window shows the total price for the selected licenses, and includes actionable elements “License Terms” and “Music Details” that, when selected, display the terms of the selected licenses, and also display one or more details associated with the media item. Thus, following the process outlined in FIGS. 2A-2P, a user of the UI 201 may select and purchase specific licenses for each media item. Each purchased media license may be placed in a searchable collection or playlist of licenses. Users can create customized playlists that include certain media items or types of media items, or include all the media items related to a certain project such as a television show or movie.

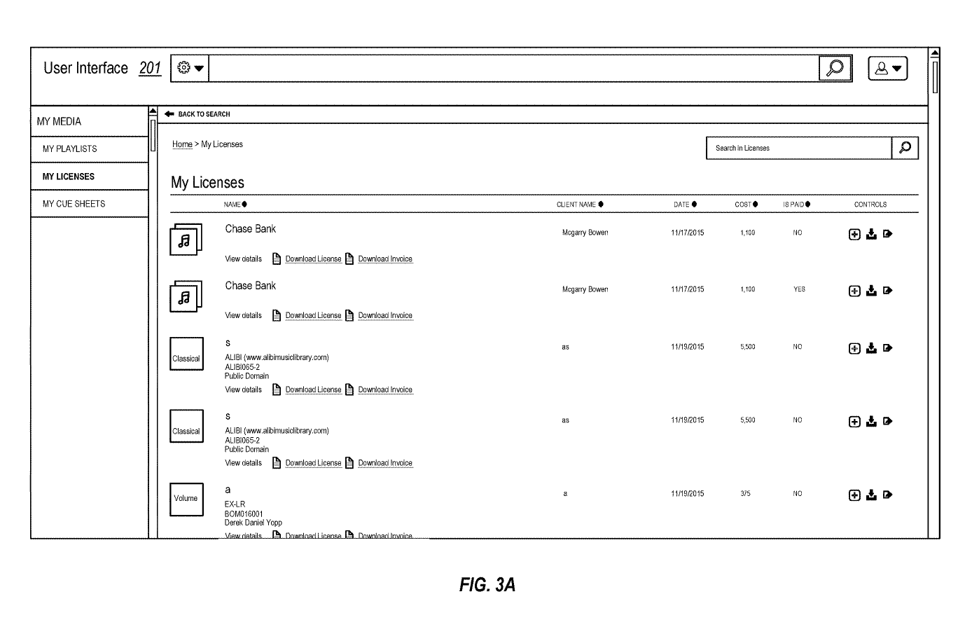

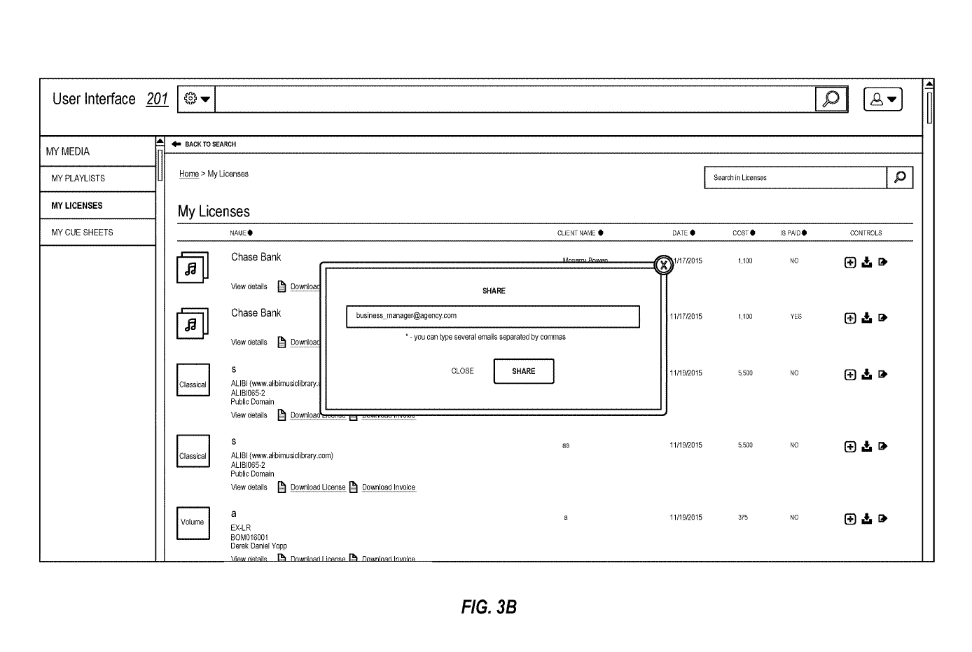

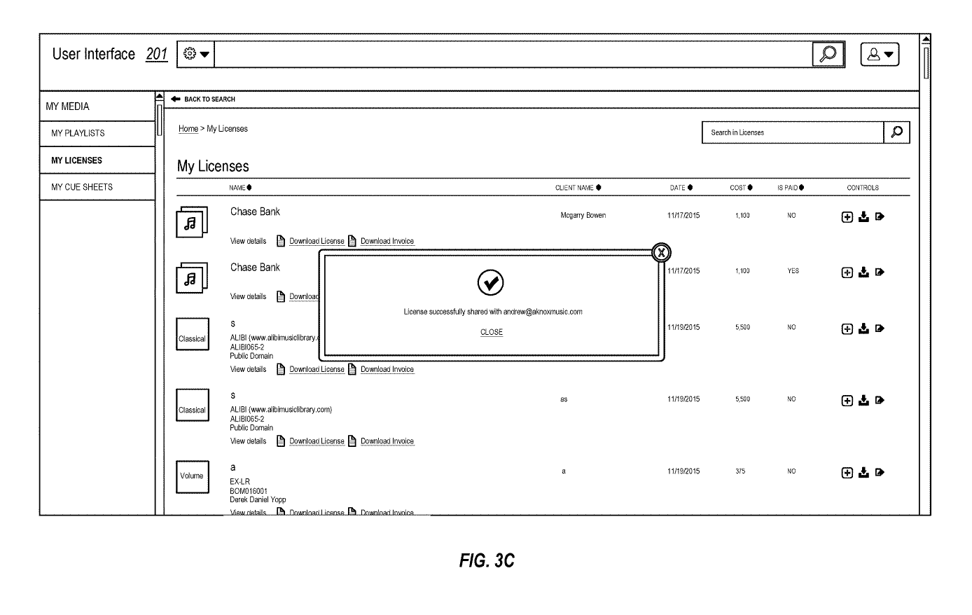

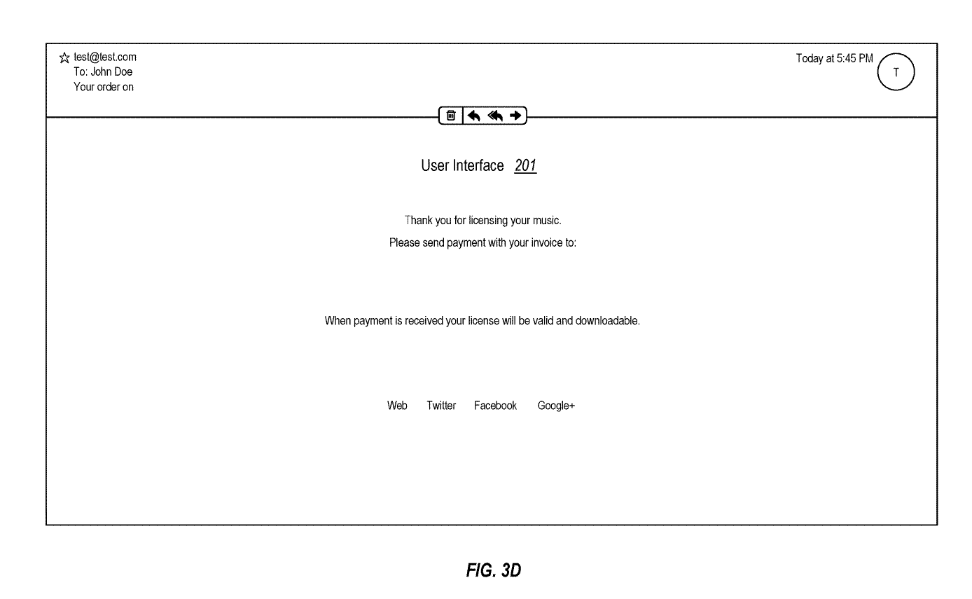

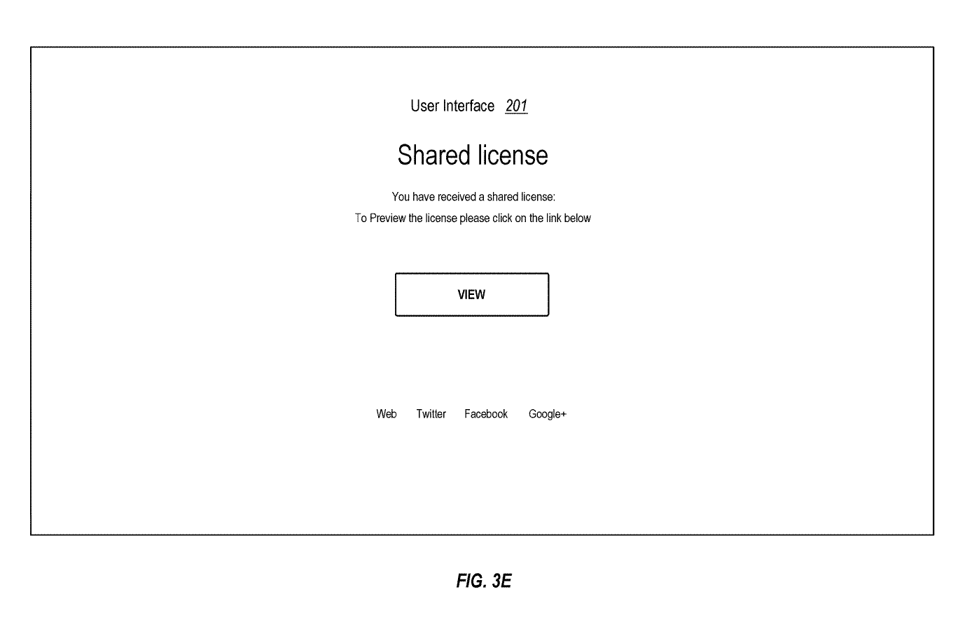

FIG. 3A illustrates an embodiment in which the user interface 201 is displaying a list of a user's purchased licenses. The list may include various licenses and license types. Each license may have information relating to the media licenses including a description of the media that is to be licensed. The UI 201 of FIG. 3A may, for example, include a UI field configured to present information identifying the owner of the media (e.g. Chase Bank). The UI may also be configured to show media items that are similar to a given media item. The UI 201 may, for example, show a list of songs that are similar to a selected song. The UI may provide actionable elements that provide access to a collection of media playlists associated with the user, to a collection of licenses associated with the user, to a collection of cue sheets associated with the user, or to other information associated with media licenses. The cue sheet, for example, may show for a given movie or television show, which songs or song snippets are to be used during an intro, scene change, montage, etc. Using a cue sheet, a user may be able to more easily manage which media items are associated with a given project such as a film or tv show.

The UI of FIG. 3A further provides options for a user to download a license or download an invoice associated with the media item. The downloadable license may be a full-form version of the license, including an identification of the media item and the terms of the license. The UI 201 may also provide controls that allow a user to share the license with other users. FIG. 3B illustrates an embodiment where a share license UI element has been selected. A window is shown in FIG. 3B which allows the user to enter the email address (or other contact information) of the individual with whom the user wishes to share the license. After providing the email address of the intended recipient, the selected media license will be shared with that recipient, as indicated in FIG. 3C. A “Thank You” screen may then be shown (e.g. FIG. 3D) along with information related to the purchased/shared license. The recipient of the shared license may receive an email or other notification (such as that shown in FIG. 3E) indicating receipt of the shared license. FIG. 3F shows an embodiment in which the recipient is viewing information related to the shared license.

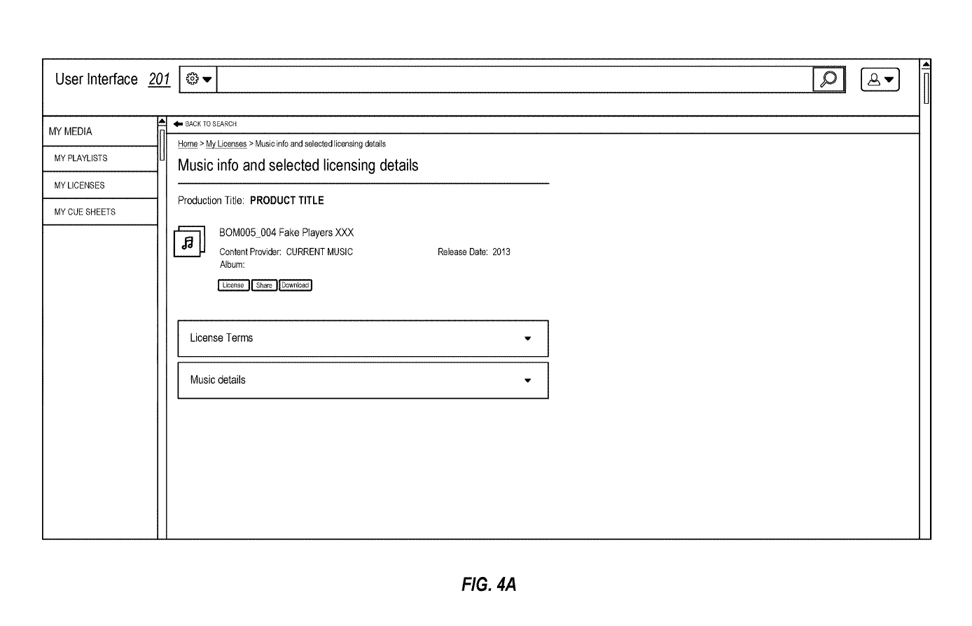

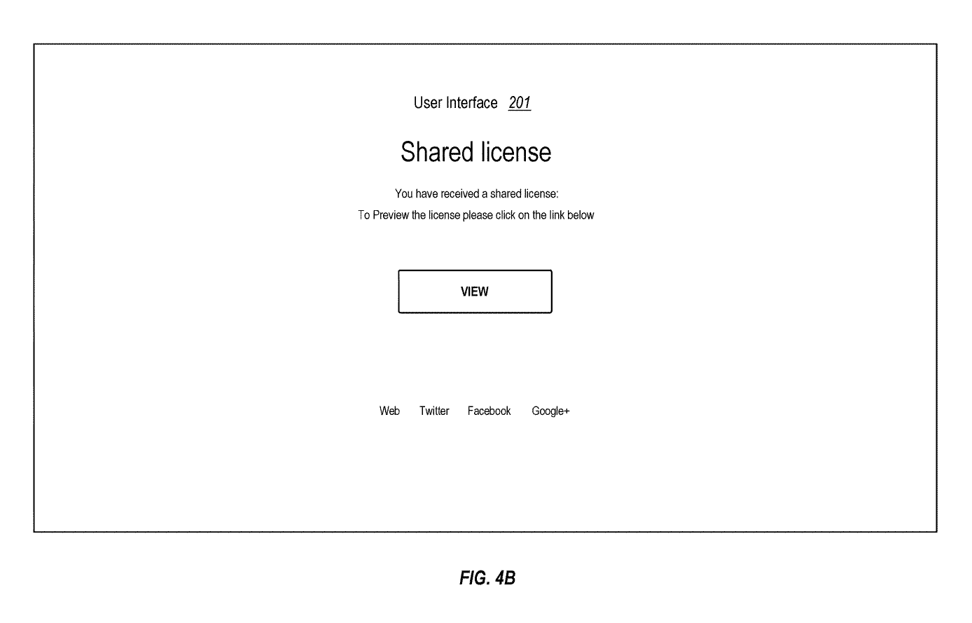

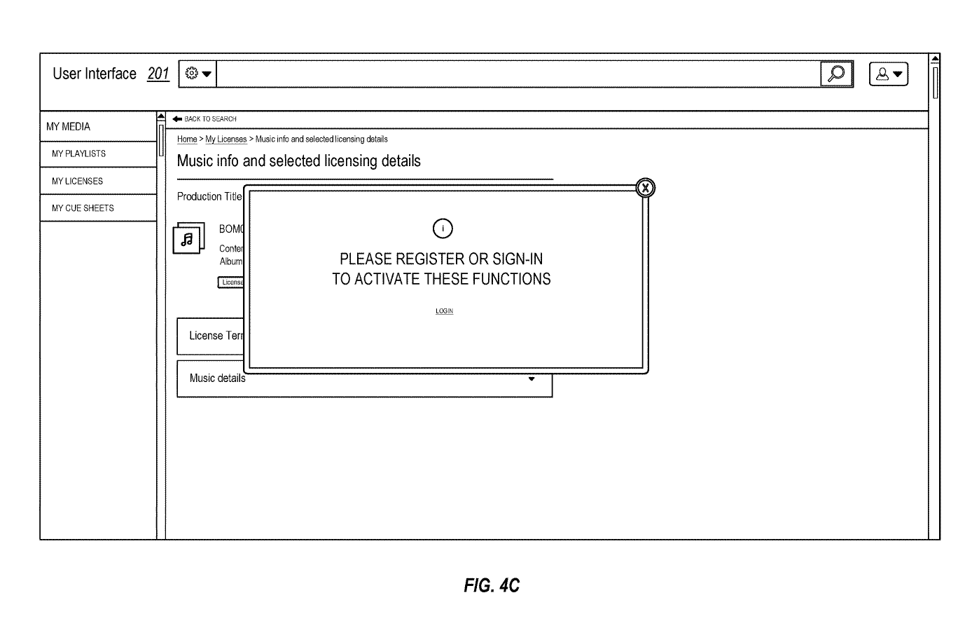

In another embodiment, the user may attempt to share a license with a user who is not yet authorized to view licenses. For instance, in FIG. 4A, the user may select to share a music track “BOM005_004 Fake Players XXX.” FIG. 4B shows, on the recipient side, an indication that a license has been shared with that user. FIG. 4C illustrates a UI window that indicates to the recipient that they are to register or log in to view the license that has been shared with them. The UI element that allows the user to share a license may be substantially any type of button, field or other actionable element that allows the user to share acquired licenses with another user. The shared license may include any type of license including non-broadcast (with sub-options of not for sale, for sale/promotional (up to 10,000 CDs/DVDs, 10-50,000, over 50,000 CDs/DVDs, live events, trade shows, theater (single, local, regional, national, worldwide), internet, broadcast commercials, broadcast programs, public venues, film, commercial packages, radio, stadium jumbo screen, public venue, transit or other license type. Each license type may also be local, regional, nationwide, or worldwide. Accordingly, many different license types and scopes are possible.

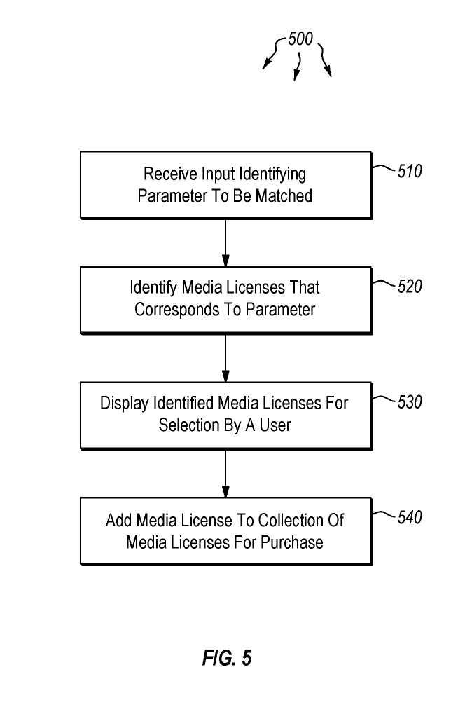

These concepts will be explained further below with regard to method 500 FIG. 5. In view of the systems and architectures described above, methodologies that may be implemented in accordance with the disclosed subject matter will be better appreciated with reference to the flow chart of FIG. 5. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 5 illustrates a flowchart of a method 500 for identifying and presenting media licenses base on parameters. The method 500 will now be described with frequent reference to the components and data of environment 100.

Method 500 includes receiving one or more inputs identifying at least one parameter that is to be matched to one or more different media licenses or media license types (510). For example, in FIG. 1, the input receiving module 105 of computer system 101 may receive input 111 identifying one or more parameters 112 that are to be matched to different media licenses 114 or media license types 115. The parameters may include media type, media item name, producer, owner, length or other type of parameter. Using these parameters, the media license identifying module 106 may identify media licenses 114 that correspond to the parameters (520).

Method 500 further includes displaying the one or more identified media licenses for selection by a user (530). For example, the display module 107 may display the identified media licenses in user interface 117 of display 116. The media licenses are displayed in a license information field 118 that includes various portions of information related to the media item. The media license type selection UI element 119 allows the user 110 to select which media license or license type they wish to view and/or purchase. Upon selection of the media license by the user, method 500 includes adding the media license to a collection of media licenses 122 that are to be purchased (540). The collection of licenses may be searchable and organizable by the user, so that various licenses are shown based on parameters or preferences provided by the user.

In some embodiments, the inputs 111 provided by the user 110 that identify one or more parameters 112 further include a project description. The project may be a television show, movie or other portion of media that involves multiple media licenses. As mentioned above, for example, a movie may include many different songs or song snippets. Each use of a song may be entered into a cue sheet corresponding to that movie. In cases where the parameters 112 input by the user are related to a specific project, identification of the media licenses that correspond to the parameters may include identifying media licenses that correspond to the project description. Thus, if the project is a film, and the film description has various terms in it, the parameters identified by the user may be matched against those terms.

The user interface 117 of display 116 may display the media licenses in the collection of media licenses 109 according to media license type. As such, all media items with a specified license type may be displayed in the user interface. In some cases, each of the media licenses that are associated with a given media item may be displayed in the UI 117. In such cases, a single media item may be displayed with multiple media licenses of different types that are associated with the first media item. When these media items are displayed, one or more portions of license usage information may also be displayed in the user interface 117. If changes are needed in the license usage information, it may be dynamically updated in real time. This information may include pricing information, which may also change and be updated in real time. User interface users may also cause the UI to displays license terms for a selected media license, including license type and valid term.

One embodiment described herein includes a computer system itself. The computer system may include the following: one or more processors 102, a display 116 for displaying information relating to one or more identified media licenses 114, an input receiver 105 for receiving input 111 indicating that a specified type of media license is to be acquired by a user 110, and a price calculating module (which may be part of the license management module 108) that determines a price for the selected type of media license. The display 116 displays the determined price for the selected type of media license, and a payment processor 121 causes payment to be processed for the selected type of media license. The purchased media license is then added to a collection of media licenses 109 including the purchased license and any previously purchased media licenses.

The user interface 117 of display 116 may further display an actionable element in the user interface that, upon selection, displays media item details associated with a selected media item. The UI 117 may also include one or more actionable elements for language dubbing, tags, commercial theme use, license terms, music uses or for performing other related functions. The price for each license may be market-demand driven or set by a specified entity. As such, the pricing structure for the media licenses may change dynamically according to market demands or according to changes made by the specified entity. The UI 117 may provide an indication of whether the media license has been paid for by the user, or has merely been added to a cart for later payment.

Accordingly, methods, systems and computer program products are provided which identify and present media licenses base on parameters. Moreover, methods, systems and computer program products are provided which allow users to select and purchase media licenses, and further organize, search through and share those licenses with others.

The concepts and features described herein may be embodied in other specific forms without departing from their spirit or descriptive characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

I claim:

1. A computer program product comprising one or more computer storage media having thereon computer-executable instructions that, when executed by one or more processors of the computing system, cause the computing system to instantiate a user interface comprising the following:
at least one first field configured to present information relating to one or more identified media licenses;
at least one first actionable element that allows selection of the type of media license to be acquired by a user for a selected media item;
at least one second field that displays a determined price for the selected type of media license; and
at least one second actionable element that processes payment for the selected type of media license, wherein the purchased license is added to a collection of media licenses comprising the purchased media license and any previously purchased media licenses.

2. The computer program product of claim 1, wherein the information relating to one or more identified media licenses comprises a description of the media that is to be licensed.

3. The computer program product of claim 1, further comprising at least one field configured to present information identifying the owner of the media.

4. The computer program product of claim 1, further comprising at least one field that provides access to a collection of media playlists associated with the user.

5. The computer program product of claim 1, further comprising at least one field that provides access to a collection of one or more licenses associated with the user.

6. The computer program product of claim 1, further comprising at least one field that provides access to a collection of one or more cue sheets associated with the user.

7. The computer program product of claim 1, further comprising a list of media items that are similar to the selected media item.

8. The computer program product of claim 1, further comprising at least one actionable element that allows the user to share one or more acquired licenses with another user.

9. The computer program product of claim 1, wherein the type of license includes at least one of non-broadcast, internet, broadcast commercials, broadcast programs, public venues, film, commercial packages, radio, stadium jumbo screen, public venue, and transit.

10. A method, implemented at a computer system that includes at least one processor, for identifying and presenting media licenses base on parameters, the method comprising:
receiving one or more inputs identifying at least one parameter that is to be matched to one or more different media licenses or media license types;
based on the at least one parameter, identifying one or more media licenses that correspond to the at least one parameter;
displaying the one or more identified media licenses for selection by a user; and
upon selection by the user, adding the media license to a collection of media licenses that are to be purchased.

11. The method of claim 10, wherein the inputs identifying the at least one parameter comprise a project description, such that identification of the one or more media licenses that correspond to the at least one parameter comprises identifying media licenses that correspond to the project description.

12. The method of claim 10, further comprising displaying the media licenses in the collection of media licenses according to media license type, such that all media items with a specified license type are displayed in the user interface.

13. The method of claim 10, further comprising displaying each of the media licenses that are associated with a given media item, such that a single media item is displayed with a plurality of media licenses of different types.

14. The method of claim 10, further comprising displaying one or more portions of license usage information in the user interface.

15. The method of claim 14, wherein the license usage information is dynamically updated in real time.

16. The method of claim 14, further comprising displaying a user interface element that, upon selection, displays license terms for a selected media license.

17. A computer system comprising the following:
one or more processors;
a display for displaying information relating to one or more identified media licenses;
an input receiver for receiving input indicating that a specified type of media license is to be acquired by a user;
a price calculating module that determines a price for the selected type of media license;
the display displaying the determined price for the selected type of media license; and
a payment processor that causes payment to be processed for the selected type of media license, wherein the purchased media license is added to a collection of media licenses comprising the purchased license and any previously purchased media licenses.

18. The computer system of claim 17, further comprising displaying an actionable element in the user interface that, upon selection, displays media item details associated with a selected media item.

19. The computer system of claim 17, wherein the user interface further includes one or more actionable elements for language dubbing, tags, commercial theme use, license terms, and/or music uses.

20. The computer system of claim 17, wherein the price of the selected media license is market-demand driven, such that the pricing structure for the media licenses changes dynamically.
